(19) United States
(12) Patent Application Publication
(10) Pub. No.: US 2002/0189989 A1
(43) Pub. Date: Dec. 19, 2002

(54) Purifier for an aquarium

(76) Inventor: Henry Cheng, Kaohsiung Hsien (TW)

Correspondence Address: Rabin & Berdo, P.C., Suite 500, 1101 14th Street, Washington, DC, 20005, US

(21) Appl. No.: 10/164,563

(22) Filed: Jun. 10, 2002

(30) Foreign Application Priority Data
Jun. 15, 2001 (TW) 090210090

(51) Int. Cl. A01K 63/04

(52) U.S. Cl. 210/169

(57) ABSTRACT

A purifier for an aquarium has a body being composed of an upper seat and a bottom seat. The upper seat has two tubular parts, two crowns respectively formed at upper ends of the tubular parts, two pipes respectively provided on the crowns and in communication with the tubular parts, and two plugs respectively provided in the crowns. The bottom seat has two rims formed at an upper surface thereof. The tubular parts are respectively secured in the rims. A pump seat is provided in the bottom seat. At least one air vent is defined through the pump seat. Two openings are defined through the bottom seat and respectively located in the rims and in communication with the pump seat. Two filtering means are respectively received in the tubular parts and communicated with the pipes. A pump is communicated with the openings.

### BACKGROUND OF THE INVENTION

1. Field of the Invention

The present invention is related to a purifier for an aquarium, and more particularly to a purifier that can filter water, neutralize poisonous components, fractionate proteinic components, and feed carbon dioxide.

2. Description of Related Art

For making a natural environment advantageous to growth of fishes, filtering devices, air pumps, illuminating devices, protein-fractionating devices must be installed in an aquarium.

These devices will occupy a large space of the aquarium and the aquarium looks ugly because of them. These devices generally must use pumps to drive, and the great noise generated by the pumps is disadvantageous to the fishes as well as people. It is also uneconomic to buy all of the separate devices when a user wants to purchase an aquarium.

Therefore, the invention provides an improved purifier for an aquarium to mitigate and/or obviate the aforementioned problems.

### SUMMARY OF THE INVENTION

The main objective of the invention is to provide a purifier for an aquarium that has functions including water-filtering, neutralizing poisonous components, fractionating proteinic components, and feeding carbon dioxide.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment in accordance with the invention;

FIG. 2 is a sectional view of the first embodiment;

FIG. 3 is a schematic view of the first embodiment used in an aquarium;

FIG. 4 is a sectional view of a second embodiment in accordance with the invention;

FIG. 5 is an exploded perspective view of a third embodiment in accordance with the invention;

FIG. 6 is a sectional view of the third embodiment;

FIG. 7 is a sectional view of a fourth embodiment in accordance with the invention;

FIG. 8 is a sectional view of a fifth embodiment in accordance with the invention; and

FIG. 9 is a schematic view of the fifth embodiment used in a filter.

### DETAILED DESCRIPTION OF THE PREFERRED EMBODIMENT

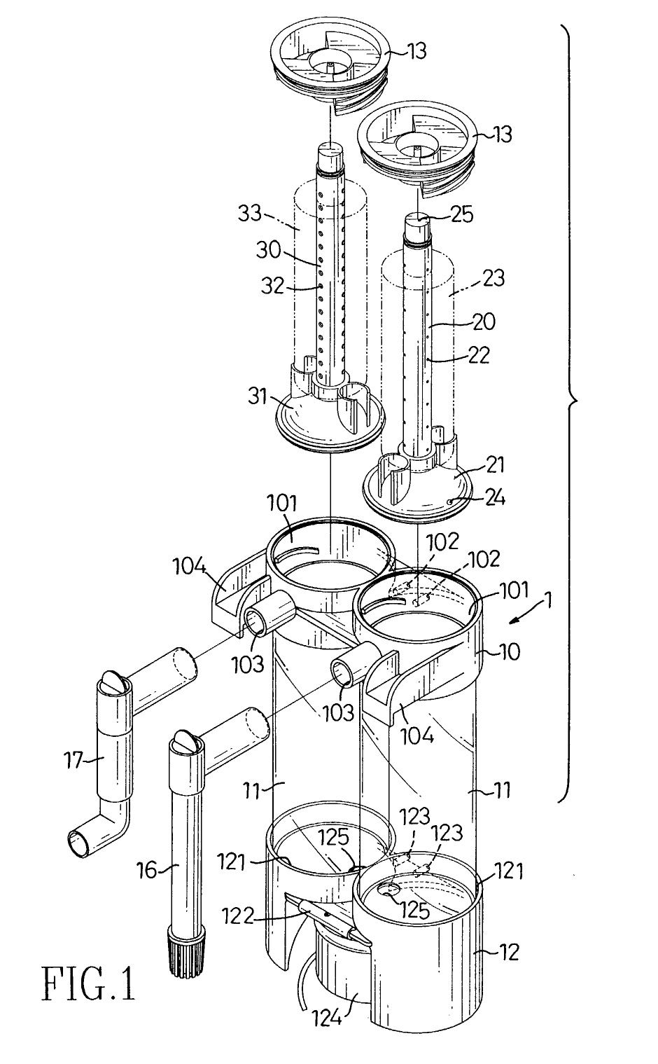

Referring to FIG. 1, in a first embodiment in accordance with the present invention, a purifier for an aquarium is composed of a body (1), a first filtering tube (20) and a second filtering tube (30) received in the body (1).

The body (1) has an upper seat (10) and a bottom seat (12). The upper seat (10) has two tubular parts (11) defined therein. Two crowns (101) are respectively provided at tops of the tubular parts (11). Two plugs (13) are provided in the crowns (101) respectively.

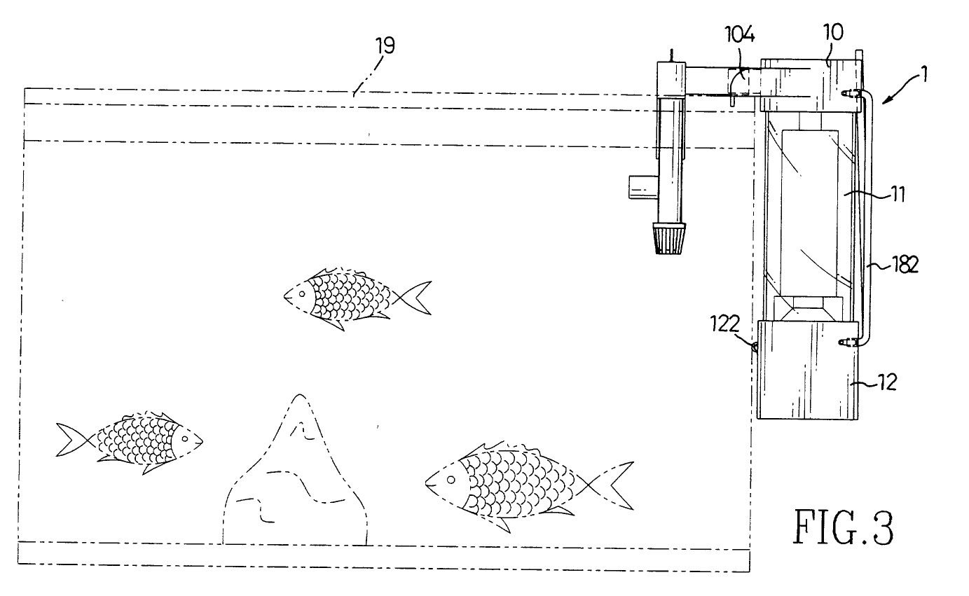

Two joints (103) are respectively formed at upper ends of the crowns (101) and communicated with the tubular part (11). Two fasteners (104) are respectively formed beside the joints (103) for attaching the purifier on an aquarium (19), as shown in FIG. 3. Referring back to FIG. 1, two lugs (102) are formed at a rear side of the crowns (101) opposite to the joints (103).

Two pipes (16, 17) are respectively connected with the joints (103), wherein water flows into the body (10) through the water-in pipe (16), and flows out through the water-out pipe (17).

The bottom seat (12) has two rims (121) formed at a top thereof and the tubular parts (11) are mounted in the rims (121) respectively. A pump seat (124) is provided under the bottom seat (12) and a cushion (122) is provided at a front side of the pump seat (124). Two air vents (123) are defined through the pump seat (124) and opposite to the cushion (122). Two openings (125) are defined through the bottom seat (12) and located in the tubular parts (11) respectively.

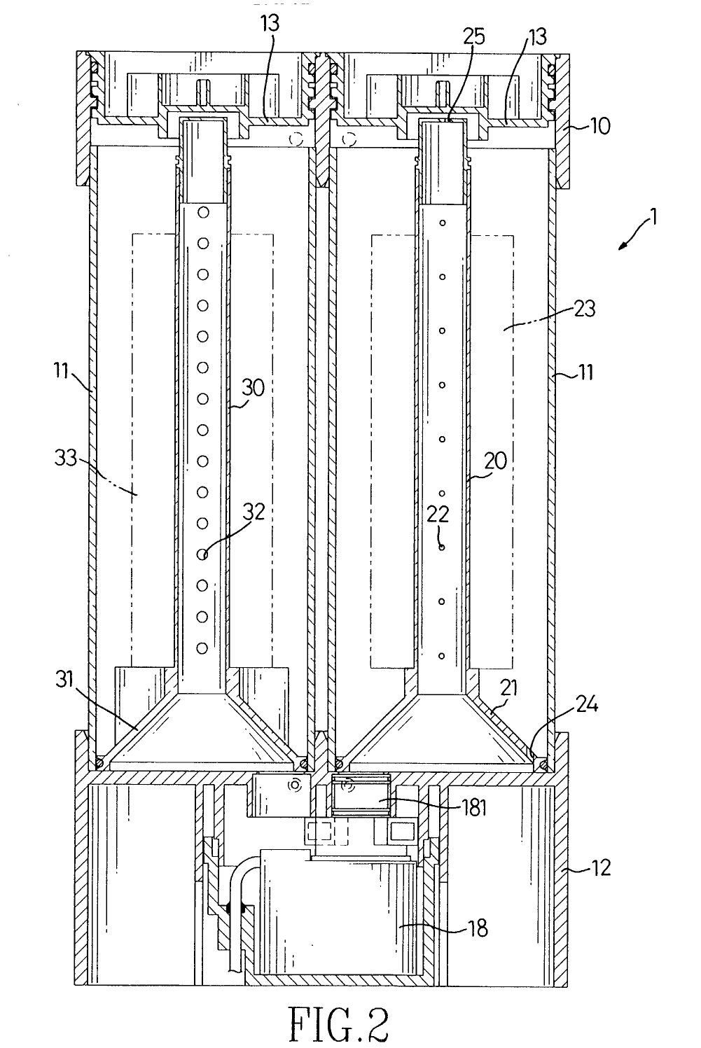

Referring to FIG. 2, a pump (18) is mounted in the pump seat (124) and has a water inlet (181) communicated with the opening (125) corresponding to the water-in pipe (16), and a water outlet (not numbered) communicated with the opening (125) corresponding to the water-out pipe (17). The air vents (123) are respectively communicated with the water inlet (181) and the water outlet. A hose (182) is connected with the air vent (123) in communication with the water inlet (181), as shown in FIG. 3, and the air vent (123) in communication with the water outlet of the pump (18) is plugged.

Referring back to FIGS. 1 and 2, the first filtering tube (20) is received in the tubular part (11) with which the water-in pipe (16) is connected, and the second filtering tube (30) is received in the tubular part (11) with which the water-out pipe (17) is connected. The filtering tubes (20, 30) each have a cone-shaped seat (21, 31) formed at the bottom end thereof. A plurality of apertures (22, 32) is evenly defined through outer peripheries of the respective filtering tubes (20, 30), wherein the first apertures (22) on the first filtering tube (20) are smaller than the second apertures (32) on the second filtering tube (30). Sponges (23, 33) are respectively provided outside the filtering tubes (20, 30) to cover the apertures (22, 32). There are ammonifying bacteria and nitrobacteria provided in the sponges (23, 33).

The first cone-shaped seat (21) of the first filtering tube (20) has a hole (24) defined therethrough. A pore (25) is defined at a top of the first filtering tube (20). The plugs (13) are mounted in the respective crowns (101) to secure the filtering tubes (20, 30) in the tubular parts (11).

Referring to FIGS. 1-3, the first embodiment is attached on the aquarium (19) and the pipes (16, 17) extend into the water in the aquarium (19). When the pump (18) is actuated, the water flows through the water-in pipe (16) in the tubular part (11) connected with the pipe (16). The water in turn flows through the first sponge (23), the first apertures (22), the first filtering tube (20), the openings (125), the second filter tube (30), the second apertures (32), the second sponge (33), and is discharged from the water-out pipe (17) in the aquarium (19). Poisonous ammonia and nitrous acid in the water can be neutralized by the ammonifying bacteria and the nitrobacteria in the sponges (22, 23), and the water is purified. Gas generated in resolving ammonia and nitrous acid can be discharged out from the pore (25).

External air can be absorbed in the pump (18) from the hose (182) and the air vent (123) to increase oxygen in the water. When the purifier is not used, the other end of the hose (182) can be connected with the lug (102).

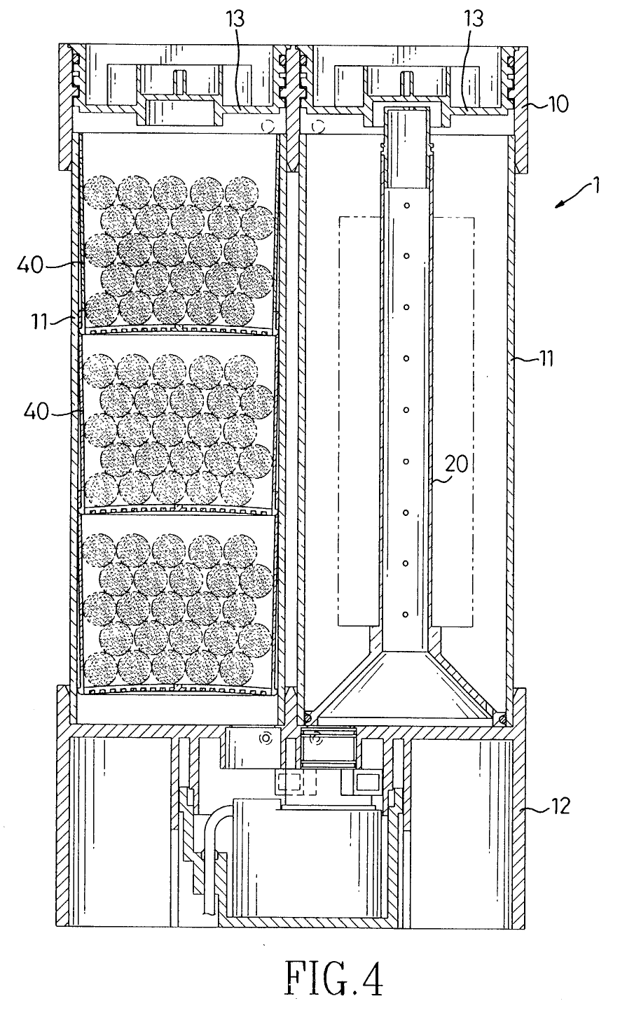

In a second embodiment illustrated in FIG. 4, the tubular part (11) connected with the water-out pipe (17) has a plurality of cups (40) stacked therein. Each of the cups (40) has filtering members, such as active carbon or corallite etc., provided therein to filter the water.

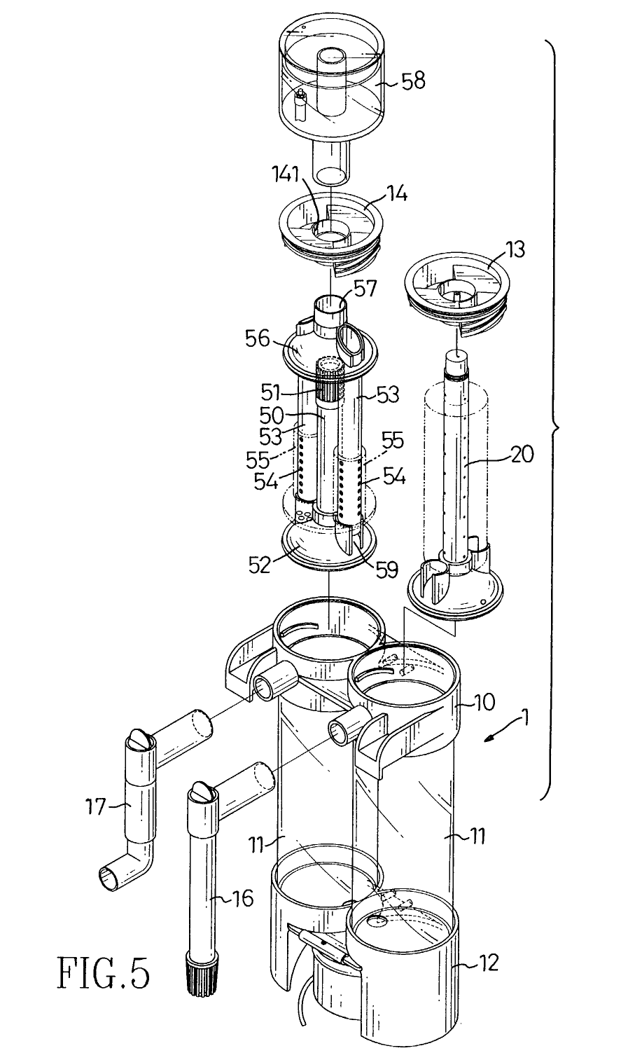

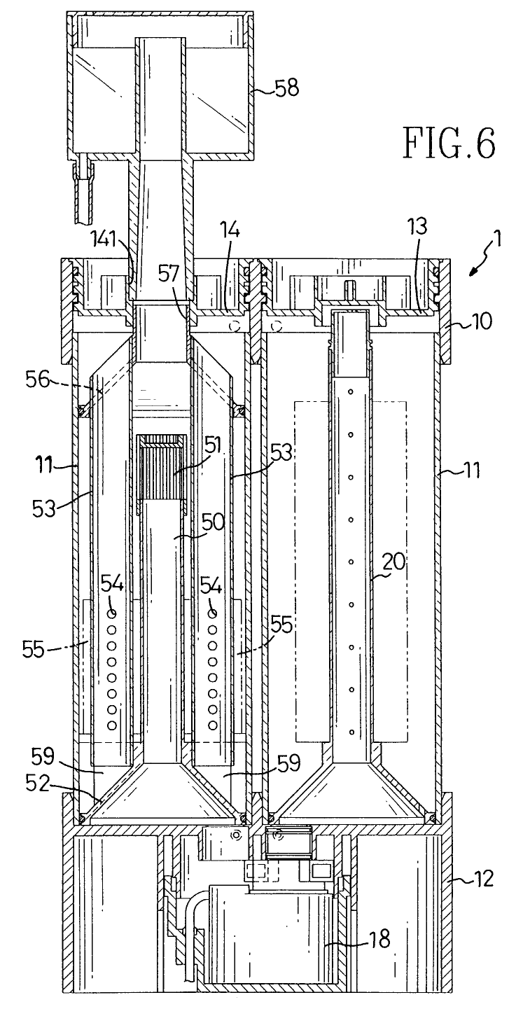

Referring to FIGS. 5 and 6, a third embodiment of the invention is illustrated. A third filtering tube (50) is received in the tubular part (11) connected with the water-out pipe (17). The third filtering tube (50) has a nozzle (51) defined at a top thereof. A third cone-shaped seat (52) is formed at a bottom end of the third filtering tube (50), and a first cone-shaped cover (56) is formed at a top end of the third filtering tube (50). Two first sub-tubes (53) are formed at diametrically opposite sides of the third filtering tube (50) and each have a notch (59) defined at a bottom thereof. Two third sponges (55) are provided outside the sub-tubes (53) respectively. The first sub-tubes (53) each have a plurality of third apertures (54) evenly defined through an outer periphery thereof. The sub-tubes (53) are not communicated with the third cone-shaped seat (52) and extend through the cone-shaped cover (56).

The cone-shaped cover (56) has an upper tube (57) defined therethrough. A second plug (14) is provided in the tubular part (11) and has a central hole (141) defined therethrough. The upper tube (57) extends through the central hole (141) of a second plug (14). A fractionating cup (58) is provided above the second plug (14) and connected with the upper tube (57).

When water from the first filtering tube (20) flows in the third filtering tube (50), the water flows out the nozzle (51) and through the third apertures (54) in the sub-tubes (53), and flows out from upper ends of the sub-tubes (53) and in a space above the cone-shaped cover (56), and is discharged from the water-out pipe (17). Proteinic bubbles in the water are absorbed in the fractionating cup (58) and are fractionated to further purify the water. Furthermore, besides filtering the water, the third sponges (54) can eliminate air bubbles in the water.

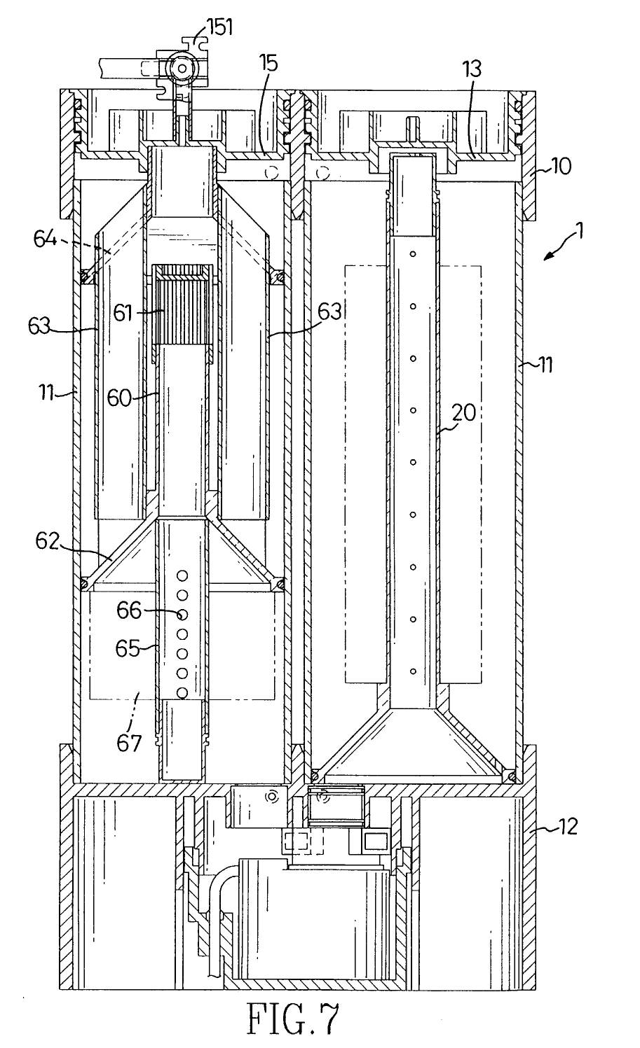

In a fourth embodiment illustrated in FIG. 7, a fourth filtering tube (60) is received in the tubular part (11) connected with the water-out pipe (17). A second nozzle (61) is defined at a top end of the fourth filtering tube (60). The fourth filtering tube (60) has a fourth cone-shaped seat (62) formed at a bottom end thereof. A second cone-shaped cover (64) is formed at a top end of the fourth filtering tube (60). Two second sub-tubes (63) are formed at diametrically opposite sides of the fourth filtering tube (60) and extend through the second cone-shaped cover (64). A bottom tube (65) is formed beneath the fourth cone-shaped seat (62) and in communication with the filtering tube (60). A plurality of fourth apertures (66) is defined through the bottom tube (65) and a fourth sponge (67) is provided outside the bottom tube (65). A third plug (15) is provided in the tubular part (11) and has a valve (151) mounted therein.

Water flows through the fourth sponge (67) and the fourth apertures (66) in the lower tube (65) and the fourth filtering tube (60), and is discharged from the second nozzle (61). Whereafter, the water flows through the second sub-tubes (63) and in a space above the second cone-shaped cover (64), and is discharged from the water-out pipe (17).

In this embodiment, carbon dioxide can be fed in the water by the hose (182) connected with the air vent (123), or by the valve (151). The carbon dioxide will be incompletely dissolved in the water, and that undissolved carbon dioxide is accumulated at an upper portion of the tubular part (1) connected with the water-out pipe (17). When the water is discharged from the second nozzle (61), the undissolved carbon dioxide can be further dissolved in the water.

This embodiment can be used for an aquarium with aquatic plants. The water containing carbon dioxide is advantageous to the growth of the aquatic plants.

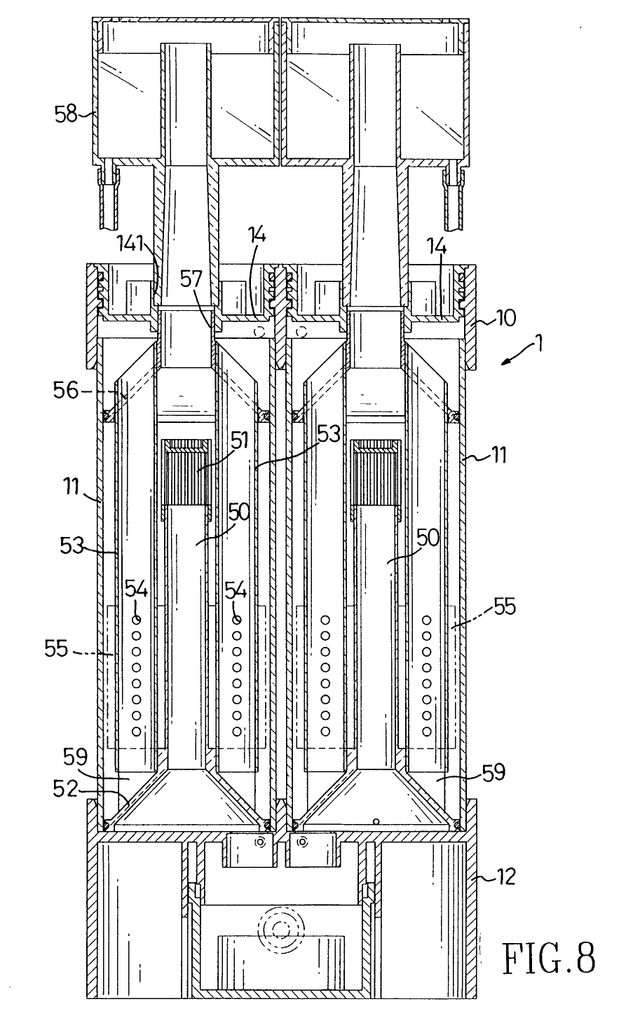

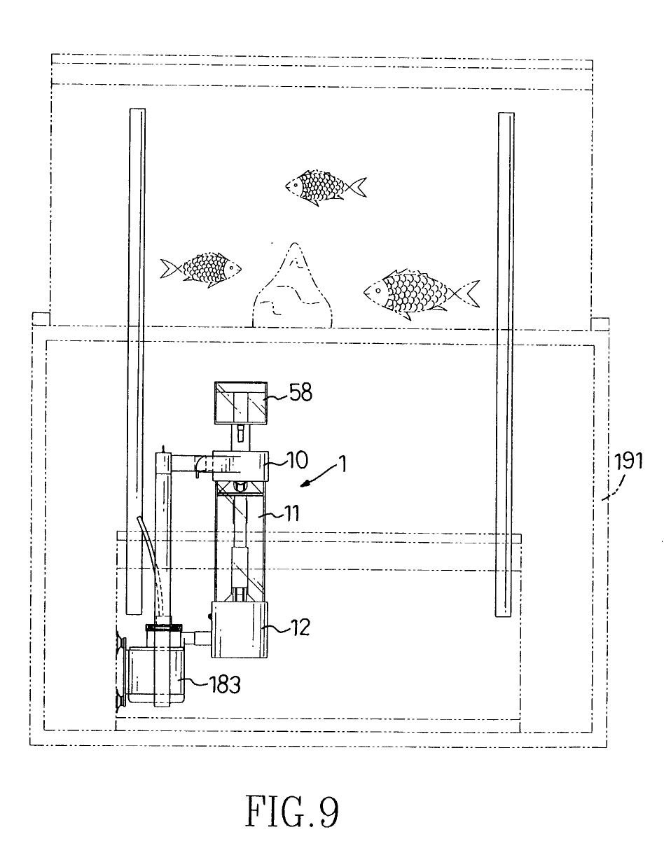

Referring to FIGS. 8 and 9, in a fifth embodiment of the invention, the purifier has two third filtering tubes (50) received in the tubular parts (11) respectively. Each of the third filtering tubes (50) has a nozzle (51) defined at a top thereof. A third cone-shaped seat (52) is formed at a bottom end of the third filtering tube (50), and a first cone-shaped cover (56) is formed at a top end of the third filtering tube (50). Two first sub-tubes (53) are formed at diametrically opposite sides of the third filtering tube (50) and each have a notch (59) defined at a bottom thereof. Two third sponges (55) are provided outside the sub-tubes (53) respectively. The first sub-tubes (53) each have a plurality of third apertures (54) evenly defined through an outer periphery thereof. The sub-tubes (53) are not communicated with the third cone-shaped seat (52) and extend through the cone-shaped cover (56).

The cone-shaped cover (56) has an upper tube (57) defined therethrough. A second plug (14) is provided in the tubular part (11) and has a central hole (141) defined therethrough. The tube (57) extends through the central hole (141) of a second plug (14). A fractionating cup (58) is provided above the second plug (14) and connected with the upper tube (57).

Two water-out pipes (17) are respectively connected with the joints (103) on the tubular parts (11). A second pump (183) with a power larger than the power of the pump (18) is connected with the bottom seat (12) for replacing the pump (18). The tubular parts (11) are communicated with the second pump (183).

Water is absorbed in the second pump (183) and flows in the tubular parts (11) and is discharged from the nozzles (51), and through the third apertures (54) in the sub-tubes (53). Afterwards, the water flows out from the upper ends of the sub-tubes (53) and in spaces above the cone-shaped covers (56), and is discharged from the water-out pipes (17). Proteinic bubbles in the water are absorbed in the fractionating cup (58) and are fractionated to further purify the water.

This embodiment is generally installed in a water-filtering container (191) under an aquarium, as shown in FIG. 9.

From the above description, it is noted that the invention has the following advantages:

1. The purifier has the replaceable filtering tubes received in the tubular parts, so that according to a user's desire, the purifier can have functions including water-filtering, neutralizing poisonous components, fractionating proteinic components, and feeding carbon dioxide.

2. The purifier has a small size and is attached outside the aquarium, so that the purifier will not occupy an inner space of the aquarium.

3. Because only one pump is provided in the purifier, the noise of the purifier when running is small, which is advantageous to growth of fishes.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A purifier for an aquarium comprising:
a body (1) being composed of an upper seat (10) and a bottom seat (12),
the upper seat (10) having two tubular parts (11), two crowns (101) respectively formed at upper ends of the tubular parts (11), two pipes (16, 17) respectively provided on the crowns (101) and in communication with the tubular parts (11), and two plugs (13) respectively provided in the crowns (101),
the bottom seat (12) having two rims (121) formed at an upper surface thereof, the tubular parts (11) respectively secured in the rims (121), a pump seat (124) provided in the bottom seat (12), at least one air vent (123) defined through the pump seat (124), two openings (125) defined through the bottom seat (12) and respectively located in the rims and in communication with the pump seat (124);
two filtering means respectively received in the tubular parts (11) and communicated with the pipes (16, 17), and
a pump (18) in communication with the openings (125).

2. The purifier as claimed in claim 1, wherein the filtering means includes a first filtering tube (20) received in one of the tubular parts (11), the first filtering tube (20) having a first cone-shaped seat (21) formed at a bottom end thereof, a hole (24) defined through the first cone-shaped seat (21), a plurality of first apertures (22) evenly defined through an outer periphery thereof, a first sponge (23) provided outside the tube (20), and a pore (25) defined at a top end thereof.

3. The purifier as claimed in claim 2, wherein the pump (18) has an inlet (181) in communication with the opening (125) in the tubular part (11) in which the first filtering tube (20) is received.

4. The purifier as claimed in claim 2, wherein the pipe in communication with the tubular part (11) in which the first filtering tube (20) is received is a water-in pipe (16).

5. The purifier as claimed in claim 2, wherein the filtering means include a second filtering tube (30) received in the other tubular part (11), the second filtering tube (30) having a second cone-shaped seat (31) formed at a bottom end thereof, a plurality of second apertures (32) evenly defined through an outer periphery thereof, and a second sponge (33) provided outside the tube (20).

6. The purifier as claimed in claim 5, wherein the pump (18) has an outlet in communication with the opening (125) in the tubular part (11) in which the second filtering tube (30) is received.

7. The purifier as claimed in claim 5, wherein the pipe in communication with the tubular part (11) in which the second filtering tube (30) is received is a water-out pipe (17).

8. The purifier as claimed in claim 2, wherein the filtering means include a third filtering tube (50) received in the other tubular part (11), the third filtering tube (50) having a first nozzle (51) defined at a top end thereof, a third cone-shaped seat (52) formed at a bottom end thereof, two first sub-tubes (52) formed at diametrically opposite sides of the third filtering tube (50) and extending through a first cone-shaped cover (56) above the nozzle (51), a plurality of third apertures (54) defined through outer peripheries of the sub-tubes (52), two third sponges (55) respectively provided outside the sub-tubes (54), an upper tube (57) formed on the first cone-shaped cover (56) and extending through a second plug (14) provided in the tubular part (11), and a fractionating cup (58) provided above the second plug (14) and connected with the upper tube (57).

9. The purifier as claimed in claim 2, wherein the filtering means include a fourth filtering tube (60) received in the other tubular parts (11), the fourth filtering tube (60) having a second nozzle (61) defined at a top end thereof, a fourth cone-shaped seat (62) formed at a bottom end thereof, two second sub-tubes (63) formed at diametrically opposite sides thereof and extending through a second cone-shaped cover (64) above the second nozzle (61), a bottom tube (65) formed beneath the fourth cone-shaped seat (62) and in communication with the filtering tube (60), a plurality of fourth apertures (66) defined through the bottom tube (65), a fourth sponge (67) provided outside the bottom tube (65), a third plug (15) provided in the tubular part (11), and a valve (151) mounted therein.

10. The purifier as claimed in claim 1, wherein the filtering means is a plurality of cups with filtering members received in the cups.

11. The purifier as claimed in claim 1, wherein the filtering means include two third filtering tubes (50) respectively received in the tubular parts (11), the third filtering tubes (50) each having a first nozzle (51) defined at a top end thereof, a third cone-shaped seat (52) formed at a bottom end thereof, two first sub-tubes (52) formed at diametrically opposite sides of the third filtering tubes (50) and extending through a first cone-shaped cover (56) above the nozzle (51), a plurality of third apertures (54) defined through outer peripheries of the sub-tubes (52), two third sponges (55) respectively provided outside the sub-tubes (54), an upper tube (57) formed on the first cone-shaped cover (56) and extending through a second plug (14) provided in the tubular part (11), and a fractionating cup (58) provided above the second plug (14) and connected with the upper tube (57).

12. The purifier as claimed in claim 11, wherein the pump (183) has an outlet in communication with the openings (125) of the tubular parts (11).

13. The purifier as claimed in claim 12, wherein the pipes in communication with the tubular parts (11) are water-out pipes (17).

14. The purifier as claimed in claim 1, wherein the upper seat (10) has two joints (103) respectively formed at a front side of the crowns (101) and the pipes (16, 17) are respectively connected with the joints (103).

15. The purifier as claimed in claim 14, wherein the upper seat (10) has two fasteners (104) respectively formed beside the joints (103) for attaching the purifier on an aquarium (19).

16. The purifier as claimed in claim 15, wherein the upper seat (10) has at least one lug (102) formed at a rear side of the crowns (101).

17. The purifier as claimed in claim 1, wherein the bottom seat (12) has a cushion (122) formed at a front side thereof.

18. The purifier as claimed in claim 1, wherein the pump (18) is mounted in the pump seat (124).

19. The purifier as claimed in claim 1, wherein the pump (18) has a hose (182) connected with the at least one air vent (123).
